(19) United States
(12) Patent Application Publication
(10) Pub. No.: US 2024/0278256 A1
(43) Pub. Date: Aug. 22, 2024

(54) DEVICE FOR RAPIDLY PROCESSING KITCHEN WASTE INTO ORGANIC FERTILIZER

(71) Applicant: JIEYANG COOPWAY INDUSTRIES CO., LTD, Jieyang (CN)

(72) Inventor: Zhiwen Liao, Jieyang (CN)

(21) Appl. No.: 18/393,605

(22) Filed: Dec. 21, 2023

(30) Foreign Application Priority Data
Feb. 16, 2023 (CN) 202310132902.X

(51) Int. Cl. B02C 18/00; B01D 53/04; B02C 18/06; B02C 18/12; B09B 3/35; B09B 3/40; C05F 9/02

(52) U.S. Cl. CPC B02C 18/0092; B01D 53/04; B02C 18/067; B02C 18/12; B09B 3/35; B09B 3/40; C05F 9/02; B01D 2253/102; B01D 2257/90; B02C 2018/188; B09B 2101/70

(57) ABSTRACT

The present disclosure discloses a device for rapidly processing kitchen waste into an organic fertilizer, including a box; a crushing mechanism, where the crushing mechanism includes a fixed cutter set, a rotating shaft and a moving cutter set, the fixed cutter set is fixedly arranged on an inner wall of the box, the rotating shaft is arranged in middle of a bottom of the box, the moving cutter set is rotatably mounted on the rotating shaft, the moving cutter set includes a plurality of moving cutters, and the moving cutter set and the fixed cutter set move relative to each other to grind the kitchen waste; a heating mechanism, where the heating mechanism is arranged in the box, and is configured to heat the kitchen waste; and a deodorizing mechanism, where the deodorizing mechanism is arranged at the bottom of the box, and is configured to deodorize the kitchen waste.

### CROSS REFERENCE TO RELATED APPLICATIONS

The present application claims the benefit of Chinese Patent Application No. 202310132902.X filed on Feb. 16, 2023, the contents of which are incorporated herein by reference in their entirety.

### TECHNICAL FIELD

The present disclosure relates to the technical field of kitchen waste treatment, and in particular, to a device for rapidly processing kitchen waste into an organic fertilizer.

### BACKGROUND

Currently, the amount of kitchen waste is produced at an amazing speed every year, imposing a great pressure on kitchen waste treatment. This also means a broad market space. Poor waste treatment not only pollutes the atmosphere and groundwater, but also causes breeding of mosquitoes that spread diseases, and seriously restricts the sustainable development of cities as a major social public hazard. With the continuous improvement of people's living standards, the proportion of kitchen waste in daily domestic waste is increasing, and its composition is becoming increasingly complex. Treatment of the kitchen waste is an important link to solving the problem of domestic waste.

It is time-consuming and laborious to clean up kitchen waste. There are mainly four schemes for kitchen waste treatment in the market: landfill, incineration, composting, and biological treatment. When a disposer is used for decomposition in biological treatment, collected kitchen waste is usually directly poured into the kitchen waste disposer, and large particles in the kitchen waste are prone to remaining and need to be crushed.

All types of kitchen waste produced by means of Chinese cooking methods include soft waste such as peels, vegetables and leaves, and hard substances such as fishbones and bones, and the kitchen waste cannot be directly discharged through a sewer system. Therefore, in the past, a usual way was to first manually remove such large-volume kitchen waste in advance in operations after meals, which was cumbersome and easily made people feel uncomfortable, thereby causing great inconvenience. In view of this, there are many types of kitchen waste treatment devices on the market at present, which reduce such collection and cleaning operations by directly crushing kitchen waste and then discharging the kitchen waste, thereby bringing convenience to the public and many families and being widely liked by consumers.

The kitchen waste disposer is a modern novel environment-friendly electrical appliance, which provides a novel method for treating waste, and is mainly configured to crush waste food, and crush the waste food in a crushing cavity for many times mainly by means of a centrifugal force and then discharge the waste food into a sewer or reuse the waste food. By changing the form of waste food for timely harmless treatment, the waste food can be crushed into slurry liquid to be directly discharged through a sewer pipeline, which can easily achieve instant, convenient and fast kitchen cleaning, and avoid the breeding of germs, mosquitoes and peculiar smell of waste food due to storage, thereby effectively optimizing a home environment.

Cutters of an existing kitchen waste disposer have a too small effective grinding area, and the cutters are all vertical sections, which easily lead to splash after colliding with food waste. The cutters have a relatively single effect on kitchen waste. In an existing grinding structure, a grinding process of a moving cutter set and a fixed cutter set is put on the same level as a grinding process of a cutter. As a result, part of the kitchen waste goes through only one of the processes, resulting in reduced efficiency, so that part of waste food is filtered out without the grinding process. The arrangement of the cutter sets is relatively simple, so that fine grinding operations cannot be completed, and the treatment of kitchen waste is not fine enough, resulting in increased difficulty in discharge.

The classification of domestic waste has been gradually performed throughout China. According to the latest classification requirements for domestic waste, daily kitchen waste mainly includes household kitchen waste, food waste, other kitchen waste, and the like. This type of waste has a high moisture content and main components including protein, fat, carbohydrates, inorganic salts, and the like, and thus is also referred to as “wet waste” and “perishable waste”. If this type of waste is not well classified, the waste may pollute other recyclable waste and produce a strong peculiar smell. However, the existing kitchen waste disposer lacks a disassembly function, and although the existing kitchen waste disposer can purify waste gas, a filter layer cannot be replaced. As a result, the purification effect may be reduced in a long time, making it impossible to effectively purify the odor of the waste gas.

Therefore, it is necessary to provide a device for rapidly processing kitchen waste into an organic fertilizer to solve the above technical problems.

### SUMMARY

With regard to the technical problems to be solved by the present disclosure, a device for rapidly processing kitchen waste into an organic fertilizer is provided.

To solve the above technical problems, the present disclosure provides a device for rapidly processing kitchen waste into an organic fertilizer, including:
a box;
a crushing mechanism, where the crushing mechanism includes a fixed cutter set, a rotating shaft and a moving cutter set, the fixed cutter set is fixedly arranged on an inner wall of the box, the rotating shaft is arranged in a middle of a bottom of the box, the moving cutter set is rotatably mounted on the rotating shaft, the moving cutter set includes a plurality of moving cutters, and the moving cutter set and the fixed cutter set move relative to each other to grind the kitchen waste;
a heating mechanism, where the heating mechanism is arranged in the box, and is configured to heat the kitchen waste; and
a deodorizing mechanism, where the deodorizing mechanism is arranged at the bottom of the box, and is configured to deodorize the kitchen waste.

Further, the fixed cutter set includes a first fixed cutter and a second fixed cutter, the first fixed cutter has a U-shaped groove, the U-shaped groove forms a first grinding groove in an upper end surface of the first fixed cutter, and a first grinding protrusion is formed on a lower end surface.

Further, the moving cutter set includes a first moving cutter and a second moving cutter, the first moving cutter and the second moving cutter are symmetrically arranged on the moving cutter set, the first moving cutter and the second moving cutter are right-handed and inclined, a side surface of the first moving cutter and a side surface of the second moving cutter are inclined planes, a lower end surface of the first moving cutter and a lower end surface of the second moving cutter are close to a bottom wall of the box, and the lower end surface of the first moving cutter and the lower end surface of the second moving cutter each are provided with a second grinding groove.

Further, the bottom wall of the box is provided with a second grinding protrusion, and the second grinding protrusion fits with the second grinding groove.

Further, an upper end surface of the first moving cutter and an upper end surface of the second moving cutter each are provided with a third grinding groove, and the third grinding groove fits with the first grinding protrusion.

Further, the inner wall of the box is provided with a third grinding protrusion, and the third grinding protrusion is in clearance fit with an outer side wall of the first moving cutter and an outer side wall of the second moving cutter in an axis direction of the rotating shaft to grind the kitchen waste.

Further, the moving cutter set further includes a third moving cutter and a fourth moving cutter, the third moving cutter and the fourth moving cutter are symmetrically arranged on the moving cutter set, the third moving cutter and the fourth moving cutter are arranged above the first moving cutter and the second moving cutter, and the third moving cutter and the fourth moving cutter each have a length less than that of the first moving cutter and that of the second moving cutter.

Further, an upper end surface of the third moving cutter is an inclined plane, a lower end surface thereof is provided with a fourth grinding protrusion, and the fourth grinding protrusion fits with the first grinding groove; and an upper end surface of the fourth moving cutter is in clearance fit with the lower end surface of the first fixed cutter to grind the kitchen waste.

Further, the heating mechanism includes a heating tube, and the heating tube is welded to the inner wall of the box.

Further, the deodorizing mechanism includes a suction ventilating fan and a filter layer, the suction ventilating fan is arranged at the bottom of the box, the suction ventilating fan is connected to the filter layer, and the filter layer is an activated carbon adsorption member.

The implementation of the present disclosure has the following beneficial effects:

The kitchen waste is crushed by means of repeated cutting and grinding, and is heated and dried and then collected, and the residue may be used as an organic fertilizer, and is suitable for home use. When the kitchen waste enters a clearance for movement of the moving cutter set and the fixed cutter set relative to each other, lumps in the kitchen waste are cut off, and noise during the operation is relatively low.

The first moving cutter and the second moving cutter each are provided with a grinding groove, and are right-handed and inclined as a whole. This can solve the problems that moving cutters of an existing kitchen waste disposer have a too small effective grinding area, the moving cutters are all vertical sections, which easily lead to splash after colliding with food waste, and the moving cutters have a relatively single effect on kitchen waste. The inclined planes of the first moving cutter and the second moving cutter provide a function of guiding the kitchen waste to the middle. In addition, the arranged grinding grooves and grinding protrusions enable the moving cutters mesh with transverse cutting teeth of the fixed cutter set, so that the kitchen waste can be cut and pulled, a length of a cutting operation section is increased, more waste is cut simultaneously, and cutting and crushing efficiency is improved.

Two moving cutters sets with different heights are arranged to improve the cutting and crushing effect, which can solve the problem that a fixed grinding ring structure of an existing grinding structure has only a single plane form, so that part of kitchen waste goes through only one of processes, resulting in reduced efficiency and increased difficulty in discharge. The treated kitchen waste falls into a lower housing by gravity and is gradually collected.

When the kitchen waste slides down along the fourth moving cutter, the first moving cutter and the second moving cutter have a greater shear force, which effectively solves the problem that the shear force is constant during cutting, which is not enough to cut waste blocks with higher hardness, resulting in frequent cutter jamming and damage of the moving cutters, so that manual intervention is reduced, and a smoother treatment process and better effect are achieved.

During treatment, the kitchen waste is heated and dried, and finally the kitchen waste is transformed into fine granular dry substances, which become an organic fertilizer for plants, and the like.

The activated carbon adsorption member can be replaced, which is simple to operate, thereby solving the problem that filtration performance is reduced due to a long use time, so that waste gas of kitchen waste cannot be purified.

Other parts not mentioned in the device are the same as those in the prior art or can be implemented by the prior art.

### BRIEF DESCRIPTION OF THE DRAWINGS

FIG. 1 is a schematic diagram showing an overall structure according to the present disclosure;

FIG. 2 is a schematic enlarged structural diagram of A of FIG. 1 according to the present disclosure;

FIG. 3 is a schematic structural diagram of a crushing mechanism according to the present disclosure;

FIG. 4 is a schematic structural diagram of a first moving cutter and a second moving cutter according to the present disclosure;

FIG. 5 is a schematic structural diagram showing fitting between a first moving cutter and a first fixed cutter according to the present disclosure;

FIG. 6 is a schematic enlarged structural diagram of D of FIG. 5 according to the present disclosure;

FIG. 7 is a schematic structural diagram showing fitting between a third grinding protrusion and a first moving cutter and a second moving cutter according to the present disclosure;

FIG. 8 is a schematic enlarged structural diagram of E of FIG. 7 according to the present disclosure;

FIG. 9 is a schematic structural diagram of a third moving cutter and a fourth moving cutter according to the present disclosure;

FIG. 10 is a schematic structural diagram showing fitting between a third moving cutter and a first fixed cutter according to the present disclosure;

FIG. 11 is a schematic enlarged structural diagram of C of FIG. 10 according to the present disclosure;

FIG. 12 is a schematic enlarged structural diagram of B of FIG. 3 according to the present disclosure;

FIG. 13 is a schematic structural diagram of a heating mechanism according to the present disclosure; and

FIG. 14 is a schematic structural diagram of a deodorizing mechanism according to the present disclosure.

In the figures: 1. Box, 11. Second grinding protrusion, 12. Third grinding protrusion, 2. Crushing mechanism, 21. Fixed cutter set, 211. First fixed cutter, 212. Second fixed cutter, 213. First grinding groove, 214. First grinding protrusion, 22. Rotating shaft, 23. Moving cutter set, 231. First moving cutter, 232. Second moving cutter, 233. Second grinding groove, 234. Third grinding groove, 235. Third moving cutter, 236. Fourth moving cutter, 237. Fourth grinding protrusion, 3. Heating mechanism, 31. Heating tube, 4. Deodorizing mechanism, 41. Suction ventilating fan, 42. Filter layer, 5. Kitchen waste.

### DETAILED DESCRIPTION

In order to make the objectives, technical solutions, and advantages of the present disclosure clearer, the present disclosure will be further described in detail below with reference to the accompanying drawings.

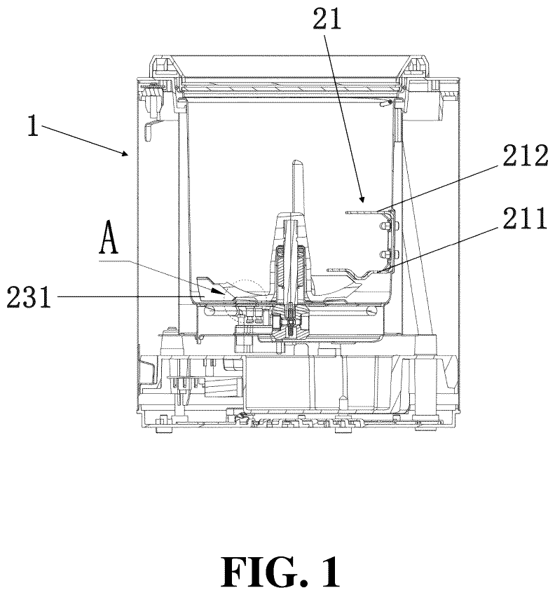

As shown in FIGS. 1 to 3, a device for rapidly processing kitchen waste into an organic fertilizer includes a box 1, a crushing mechanism 2, a heating mechanism 3, and a deodorizing mechanism 4.

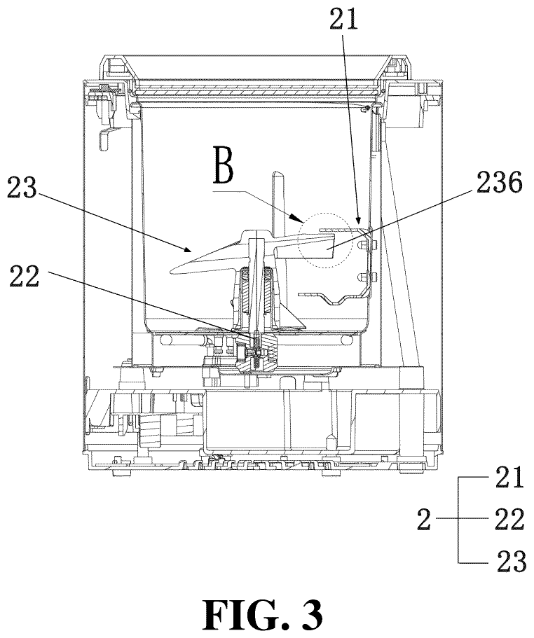

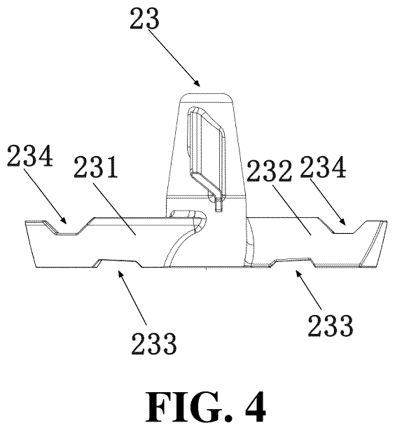

As shown in FIGS. 3 and 4, the crushing mechanism 2 includes a fixed cutter set 21, a rotating shaft 22 and a moving cutter set 23, the fixed cutter set 21 is fixedly arranged on an inner wall of the box 1, the rotating shaft 22 is arranged in a middle of a bottom of the box 1, the moving cutter set 23 is rotatably mounted on the rotating shaft 22, the moving cutter set 23 includes a plurality of moving cutters, and the moving cutter set 23 and the fixed cutter set 21 move relative to each other to grind the kitchen waste.

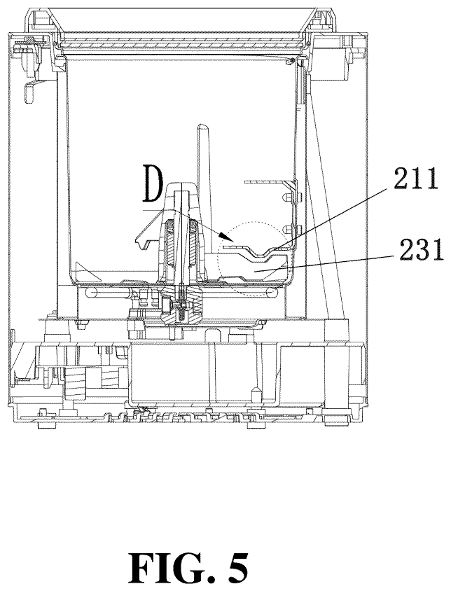

As shown in FIG. 5, the fixed cutter set 21 includes a first fixed cutter 211 and a second fixed cutter 212, the first fixed cutter 211 has a U-shaped groove, the U-shaped groove forms a first grinding groove 213 in an upper end surface of the first fixed cutter 211, and a first grinding protrusion 214 is formed on a lower end surface.

As shown in FIG. 4, the moving cutter set 23 includes a first moving cutter 231 and a second moving cutter 232, the first moving cutter 231 and the second moving cutter 232 are symmetrically arranged on the moving cutter set 23, the first moving cutter 231 and the second moving cutter 232 are right-handed and inclined, a side surface of the first moving cutter 231 and a side surface of the second moving cutter 232 are inclined planes, a lower end surface of the first moving cutter 231 and a lower end surface of the second moving cutter 232 are close to a bottom wall of the box 1, and the lower end surface of the first moving cutter 231 and the lower end surface of the second moving cutter 232 each are provided with a second grinding groove 233.

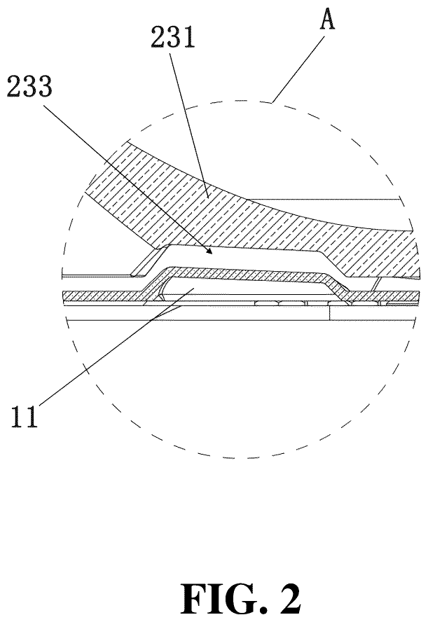

As shown in FIG. 2, the bottom wall of the box 1 is provided with a second grinding protrusion 11, and the second grinding protrusion 11 fits with the second grinding groove 233.

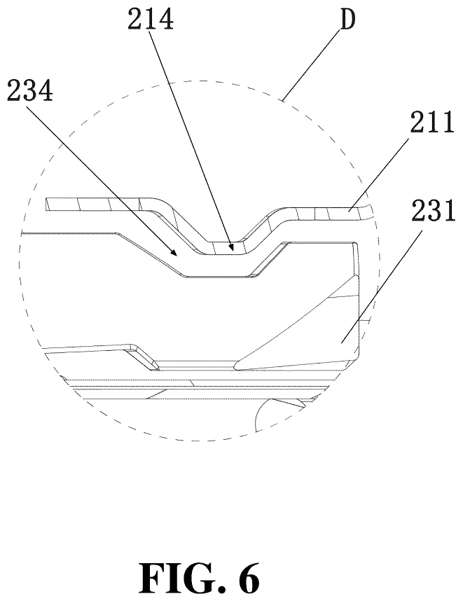

As shown in FIGS. 5 and 6, an upper end surface of the first moving cutter 231 and an upper end surface of the second moving cutter 232 each are provided with a third grinding groove 234, and the third grinding groove 234 fits with the first grinding protrusion 214.

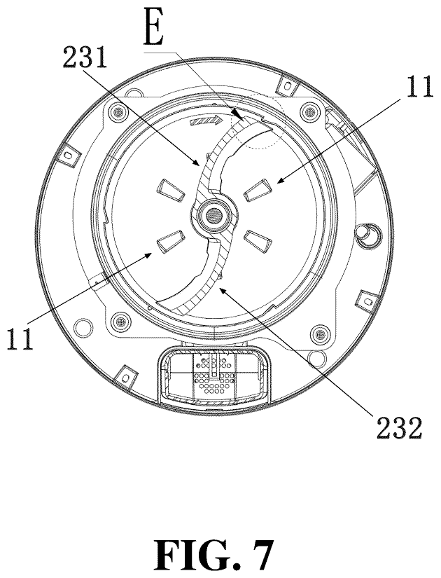

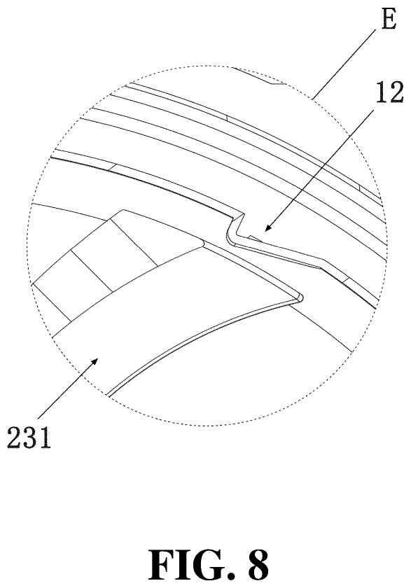

As shown in FIGS. 7 and 8, the inner wall of the box 1 is provided with a third grinding protrusion 12, and the third grinding protrusion 12 is in clearance fit with an outer side wall of the first moving cutter 231 and an outer side wall of the second moving cutter 232 in an axis direction of the rotating shaft 22 to grind the kitchen waste.

The first moving cutter 231 and the second moving cutter 232 each are provided with a grinding groove, and are right-handed and inclined as a whole, which can solve the problems that moving cutters of an existing kitchen waste disposer have a too small effective grinding area, the moving cutters are all vertical sections, which easily lead to splash after colliding with food waste, and the moving cutters have a relatively single effect on kitchen waste. The inclined planes of the first moving cutter 231 and the second moving cutter 232 provide a function of guiding the kitchen waste to the middle. In addition, the arranged grinding grooves and grinding protrusions enable the moving cutters mesh with transverse cutting teeth of the fixed cutter set 21, so that the kitchen waste can be cut and pulled, a length of a cutting operation section is increased, more waste is cut simultaneously, and cutting and crushing efficiency is improved.

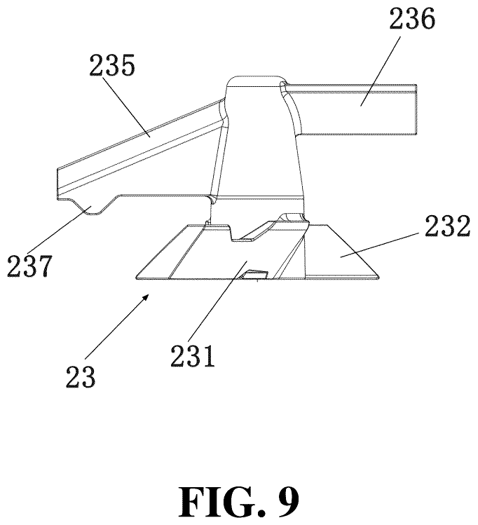

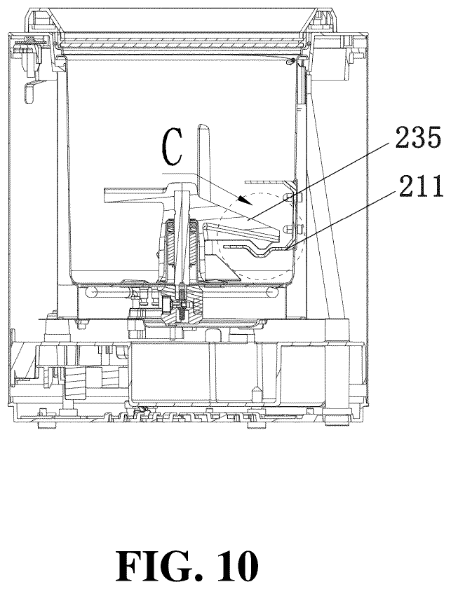

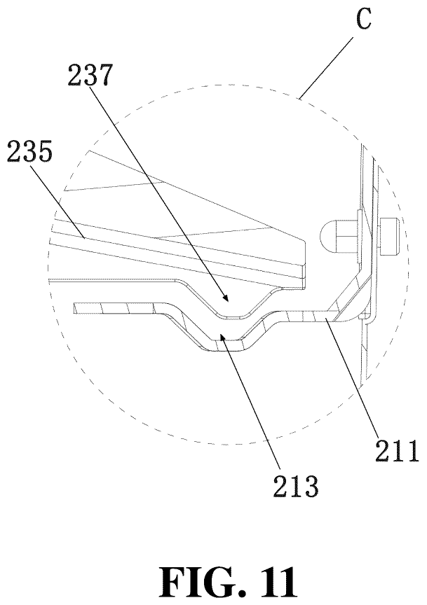

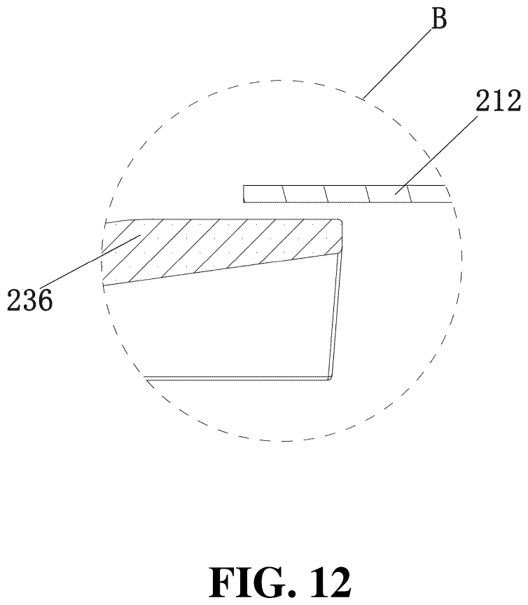

As shown in FIGS. 9 to 12, the moving cutter set 23 further includes a third moving cutter 235 and a fourth moving cutter 236, the third moving cutter 235 and the fourth moving cutter 236 are symmetrically arranged on the moving cutter set 23, the third moving cutter 235 and the fourth moving cutter 236 are arranged above the first moving cutter 231 and the second moving cutter 232, and the third moving cutter 235 and the fourth moving cutter 236 each have a length less than that of the first moving cutter 231 and that of the second moving cutter 232. An upper end surface of the third moving cutter 235 is an inclined plane, a lower end surface thereof is provided with a fourth grinding protrusion 237, and the fourth grinding protrusion 237 fits with the first grinding groove 213; and an upper end surface of the fourth moving cutter is in clearance fit with the lower end surface of the first fixed cutter 211 to grind the kitchen waste.

When the kitchen waste slides down along the fourth moving cutter, the first moving cutter 231 and the second moving cutter 232 have a greater shear force, which effectively solves the problem that the shear force is constant during cutting, which is not enough to cut waste blocks with higher hardness, resulting in frequent cutter jamming and damage of the moving cutters, so that manual intervention is reduced, and a smoother treatment process and better effect are achieved.

Two sets of moving cutters with different heights are arranged to improve the cutting and crushing effect, which can solve the problem that a fixed grinding ring structure of an existing grinding structure has only a single plane form, so that part of kitchen waste goes through only one of processes, resulting in reduced efficiency and increased difficulty in discharge. The treated kitchen waste falls into a lower housing by gravity and is gradually collected.

The kitchen waste is crushed in a way of repeated cutting and grinding, and is heated and dried and then collected, and the residue may be used as an organic fertilizer, and is suitable for home use. When the kitchen waste enters a clearance for movement of the moving cutter set 23 and the fixed cutter set 21 relative to each other, lumps in the kitchen waste are cut off, and noise during the operation is relatively low.

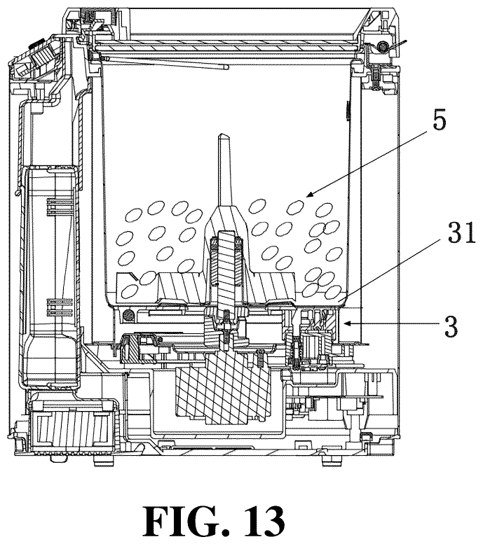

As shown in FIG. 13, the heating mechanism 3 is arranged in the box 1, and is configured to heat the kitchen waste; and the heating mechanism 3 includes a heating tube 31, and the heating tube 31 is welded to the inner wall of the box 1.

During treatment, the kitchen waste is heated and dried, and finally the kitchen waste is transformed into fine granular dry substances, which can be used for a fertilizer for plants, and the like.

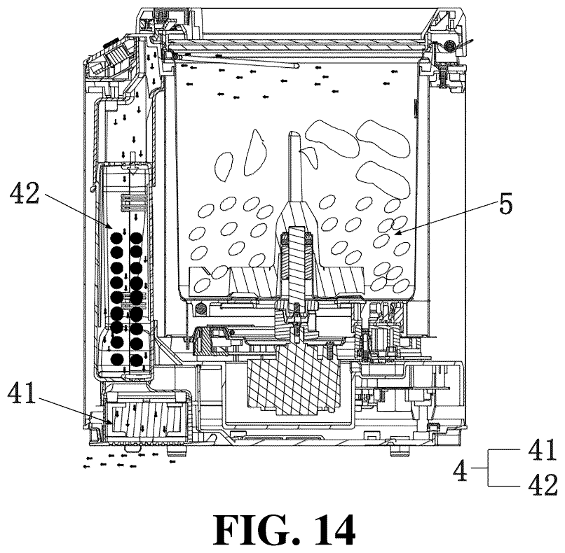

As shown in FIG. 14, the deodorizing mechanism is arranged at the bottom of the box 1, and is configured to deodorize the kitchen waste; the deodorizing mechanism 4 includes a suction ventilating fan 41 and a filter layer 42, the suction ventilating fan 41 is arranged at the bottom of the box 1, the suction ventilating fan 41 is connected to the filter layer 42, and the filter layer 42 is an activated carbon adsorption member. The activated carbon adsorption member can be replaced, which is simple to operate, thereby solving the problem that filtration performance is reduced due to a long use time, so that waste gas of kitchen waste cannot be purified.

The above disclosed is only a preferred embodiment of the present disclosure and, certainly, cannot be used to limit the scope of the claims of the present disclosure. Therefore, equivalent changes made according to the claims of the present disclosure shall still fall within the scope of the present disclosure.

1. A device for rapidly processing kitchen waste into an organic fertilizer, comprising:
a box (1);
a crushing mechanism (2), wherein the crushing mechanism (2) comprises a fixed cutter set (21), a rotating shaft (22) and a moving cutter set (23), the fixed cutter set (21) is fixedly arranged on an inner wall of the box (1), the rotating shaft (22) is arranged in a middle of a bottom of the box (1), the moving cutter set (23) is rotatably mounted on the rotating shaft (22), the moving cutter set (23) comprises a plurality of moving cutters, and the moving cutter set (23) and the fixed cutter set (21) move relative to each other to grind the kitchen waste;
a heating mechanism (3), wherein the heating mechanism (3) is arranged in the box (1), and is configured to heat the kitchen waste; and
a deodorizing mechanism (4), wherein the deodorizing mechanism is arranged at the bottom of the box (1), and is configured to deodorize the kitchen waste.

2. The device for rapidly processing kitchen waste into an organic fertilizer according to claim 1, wherein the fixed cutter set (21) comprises a first fixed cutter (211) and a second fixed cutter (212), the first fixed cutter (211) has a U-shaped groove, the U-shaped groove forms a first grinding groove (213) in an upper end surface of the first fixed cutter (211), and a first grinding protrusion (214) is formed on a lower end surface.

3. The device for rapidly processing kitchen waste into an organic fertilizer according to claim 2, wherein the moving cutter set (23) comprises a first moving cutter (231) and a second moving cutter (232), the first moving cutter (231) and the second moving cutter (232) are symmetrically arranged on the moving cutter set (23), the first moving cutter (231) and the second moving cutter (232) are right-handed and inclined, a side surface of the first moving cutter (231) and a side surface of the second moving cutter (232) are inclined planes, a lower end surface of the first moving cutter (231) and a lower end surface of the second moving cutter (232) are close to a bottom wall of the box (1), and the lower end surface of the first moving cutter (231) and the lower end surface of the second moving cutter (232) each are provided with a second grinding groove (233).

4. The device for rapidly processing kitchen waste into an organic fertilizer according to claim 3, wherein the bottom wall of the box (1) is provided with a second grinding protrusion (11), and the second grinding protrusion (11) fits with the second grinding groove (233).

5. The device for rapidly processing kitchen waste into an organic fertilizer according to claim 3, wherein an upper end surface of the first moving cutter (231) and an upper end surface of the second moving cutter (232) each are provided with a third grinding groove (234), and the third grinding groove (234) fits with the first grinding protrusion (214).

6. The device for rapidly processing kitchen waste into an organic fertilizer according to claim 3, wherein the inner wall of the box (1) is provided with a third grinding protrusion (12), and the third grinding protrusion (12) is in clearance fit with an outer side wall of the first moving cutter (231) and an outer side wall of the second moving cutter (232) in an axis direction of the rotating shaft (22) to grind the kitchen waste.

7. The device for rapidly processing kitchen waste into an organic fertilizer according to claim 3, wherein the moving cutter set (23) further comprises a third moving cutter (235) and a fourth moving cutter (236), the third moving cutter (235) and the fourth moving cutter (236) are symmetrically arranged on the moving cutter set (23), the third moving cutter (235) and the fourth moving cutter (236) are arranged above the first moving cutter (231) and the second moving cutter (232), and the third moving cutter (235) and the fourth moving cutter (236) each have a length less than that of the first moving cutter (231) and that of the second moving cutter (232).

8. The device for rapidly processing kitchen waste into an organic fertilizer according to claim 7, wherein an upper end surface of the third moving cutter (235) is an inclined plane, a lower end surface thereof is provided with a fourth grinding protrusion (237), and the fourth grinding protrusion (237) fits with the first grinding groove (213); and an upper end surface of the fourth moving cutter (236) is in clearance fit with the lower end surface of the first fixed cutter (211) to grind the kitchen waste.

9. The device for rapidly processing kitchen waste into an organic fertilizer according to claim 1, wherein the heating mechanism (3) comprises a heating tube (31), and the heating tube (31) is welded to the inner wall of the box (1).

10. The device for rapidly processing kitchen waste into an organic fertilizer according to claim 1, wherein the deodorizing mechanism (4) comprises a suction ventilating fan (41) and a filter layer (42), the suction ventilating fan (41) is arranged at the bottom of the box (1), the suction ventilating fan (41) is connected to the filter layer (42), and the filter layer (42) is an activated carbon adsorption member.
